(19) United States
(12) Patent Application Publication
(10) Pub. No.: US 2013/0295231 A1
(43) Pub. Date: Nov. 7, 2013

(54) COMESTIBLE PRODUCT

(71) Applicants: Fotis Spyropoulos, Bearwood (GB); Abigail Belinda Norton, Marborne (GB); Ian Timothy Norton, Birmingham (GB)

(72) Inventors: Fotis Spyropoulos, Bearwood (GB); Abigail Belinda Norton, Marborne (GB); Ian Timothy Norton, Birmingham (GB)

(73) Assignee: The University of Birmingham, Birmingham (GB)

(21) Appl. No.: 13/641,817

(22) PCT Filed: Apr. 19, 2011
(86) PCT No.: PCT/GB2011/050768

§ 371 Date: Jan. 29, 2013

(30) Foreign Application Priority Data
Apr. 21, 2010 (GB) 1006628.0

(51) Int. Cl. A23L 1/29

(52) U.S. Cl. CPC A23L 1/293
USPC 426/72; 426/573; 426/575; 426/577

(57) ABSTRACT

The application relates to comestible products comprising acid gellable hydrocolloids, such as low acyl gellan gum. These are used for appetite suppression. On ingesting the product the hydrocolloid gels in the stomach. Mixed hydrocolloids, such as pectin and gellan gums are also provided.

The invention relates to appetite suppressing comestible products and to their use in suppressing appetite in subjects.

Increasing levels of morbid obesity, especially within young people, is an increasing cause of concern. The trend in increasing levels of morbid obesity does not appear to be slowing and the condition is commonly associated with other chronic diseases such as heart disease, type II diabetes, hypertension and osteoarthritis as well as a range of physiological effects, such as low self-esteem, eating disorders and depression.

Besides the important health issues associated with the worldwide rising obesity problem there are also significant economic concerns.

Existing technology to reduce obesity involved the development of healthier alternatives to “unhealthy” food formulations containing high levels of fat and/or sugar and/or salt. Although consumers fully accept the potential health benefits associated with the consumption of such healthy food products, they do not seem to compromise in terms of eating the experience that these should provide. As a result, in order for the available technology to manage and shift the population's eating habits towards a more healthy diet, the texture and taste of such healthy products, as perceived from the consumption, should be designed to at least be the same as that for their unhealthy equivalents. This is far from being a trivial task as components such as fat and sugar directly influence both texture and taste of foods.

Research has shown that one potential way of having soft or liquid foods that change the way people feel and their energy intake, is to use materials that respond to the environment that they find themselves in. Hoad et al (J. Nutrition (2004), 134, pages 2293-2300), investigated a food that is structured by a hydrocolloid. Alginate gel was investigated and shown that such a gel self-assembles in the stomach to form a gel within the stomach.

Norton et al (Food Hydrocolloids (2006) 20, pages 229-239), show that the onset of hunger can be delayed by several hours using alginate gels.

These papers and a paper by Pelkman et al (J. Clin. Nutrition (2007) 86, 1595-1602), have shown that the desire to re-eat can be effected by gelling the stomach contents. However, observation showed that only a limited gelation rate occurred. The alginate gels utilised were relatively weak, producing reduced satiety effects.

A number of problems have been identified by the current inventors, including that the prior art gels were not controllably or manipulated, resulting in incomplete gelation of the stomach contents. Alginate is calcium-sensitive, thus producing potential problems with calcium-containing foods such as milk. Alternatives to alginate were not investigated and the micro structure control of mixtures of hydrocolloids was not explored. Neither was the rate of availability of the alginate for acid gelation as it was released as a calcium fluid gel.

The inventors have recognised that there is a need for improved appetite suppressing products.

The inventors identified that gellan gums could be used in appetite suppressing products.

Gellan gums are polymers of a tetrasaccharide which consists of two residues of D-glucose and one of each residue of L-rhamnose and D-glucuronic acid. The gum is a naturally occurring capsular polysaccharide produced by a bacterium, Sphingomonas elodea. It is available in two forms: the native or high acyl (HA) form which comprises two acyl substituents, acetate and glycerate. Both substituents are located on the same glucose residue and, on average, there is one glycerate per repeat unit and one acetate per every two repeat units. A second, low acyl (LA) form is commercially available. The acyl groups have been removed to produce a linear repeat unit substantially lacking in both groups. Deacylation of the gum is usually carried out by treating a fermentation broth with alkali

The inventors recognise that low acyl gellan gums are particularly advantageous because they are gellable in the presence of an acid. The stomach contents of the typical person are highly acidic (typically a pH of 2 or below). Accordingly, the acidic content of the stomach can be used to gel the gellan gum. This means that products containing the gum can be provided as, for example, liquid or soft food form, which is more palatable to consumers, and then will gel in situ within the stomach.

The invention provides an appetite suppressing comestible product comprising an acid gellable gellan gum. Preferably the gellan gum is a low acyl gellan gum.

The inventors have found that using a concentration of 1.5%-5% by weight, or 2-4% by weight of gellan gum, produces a particularly advantageous gel within the stomach. That gel has a sponge-like texture.

The texture of the comestible product may be varied by adding one or more additional hydrocolloids. Such hydrocolloids are typically food-grade hydrocolloids and are edible. One example of such a hydrocolloid is alginate. Alginate is a readily available hydrocolloid food product. Suitable acid sensitive hydrocolloid systems include alginates and pectins. High acyl gellan may also be used.

Where mixtures of such hydrocolloids are used, the total amount of the acid gellable hydrocolloid and acid sensitive hydrocolloid is typically 1.5% to 5% by weight, or 2-4% by weight.

The weight ratio of the acid gellable hydrocolloid and the one or more additional hydrocolloids, may be 80 to 20 wt % acid gellable hydrocolloid (e.g. low acyl gellan) and 20 to 80 wt % additional hydrocolloids, typically 60 to 40 wt % and 40 to 60% wt % or 50 wt %, based on the total amount of the acid gellable hydrocolloid and acid sensitive hydrocolloids used.

A mixture of a high acyl and a low acyl gellan gum may be used.

Alternatively, a mixture of a low acyl gellan gum and pectin, such as (low methoxy) pectin, may be used.

(Low methoxy) pectin is commercially available and generally known in the art.

Additionally, the product may comprise an energy release material, such as a carbohydrate. Such carbohydrates include starch granules and sugars. Oil droplets may also be used. The starch may be cross-linked starch. Preferably the food energy release material is designed to allow the slow release of energy over time, thus maintaining energy levels, without the need for further intake of food.

Macro nutrients can be incorporated with these energy release materials.

The energy release material may be encapsulated in a hydrocolloid shell. The shell structure will be broken down slowly over a period of time by gastric fluids after ingestion to release the energy material. The hydrocolloid shells may be single, double or triple shells or preferably a mixture of these to provide structures that breakdown at different rates for energy release over a period of hours. Such shells are generally known in the art.

Shells can also include starch such as a Guar or xanthan gum modified starch or ion resistant material such as alginates or carrageenan.

The product may additionally comprise one or more flavourings or colourings. Such flavourings or colouring will normally be food-grade and may include, for example, sweeteners such as aspartame or colourings to improve the taste and look of the product.

Typically the product is provided in the form of a drink or a soft food, such as a paste.

The materials described above may be mixed with water to form the product. The invention also provides a method of suppressing appetite comprising consuming a product according to the invention.

The product may be utilised, for example, as part of a calorie controlled diet in order to reduce the desire to eat between meals.

A further aspect of the invention provides a product according to the invention for use to suppress appetite.

A still further aspect of the invention provides a product according to the invention for use in the manufacture of a medicament to suppress appetite.

### FIGURES CAPTIONS

FIG. 1. True Stress/True strain curves for 2% gellan gel. Each curve is the mean of at least three repeats; error bounds are plus/minus a single standard deviation.

FIG. 2. Young's modulus and total work of failure for 2% gellan gel as a function of pH. Individual stress/strain curves were analysed to obtain the errors. Error bars are plus/minus a single standard deviation.

FIG. 3. Photographs of a 3% gellan gel at pH 2 as compressed and after compression. The sequence of photographs shows that water is released from the gel at all strains and that as the strain is removed the water is re-absorbed by the gel, which recovers some of its structure.

FIG. 4. Effect of hydrocolloid concentration on the structure of gellan acid gels. True stress/true strain curves at pH 3 and 5. Each curve is the mean of at least 3 measurements; error bars are plus/minus a single standard deviation.

FIG. 5. Young's modulus as a function of gellan concentration at pH 3 and 5. The points represent three repeats and the single standard deviations are within the symbols.

FIG. 6. True stress/true stain curves for gellan gels at pH 2. Each curve is the mean of three repeats and the error bars are plus/minus a standard deviation.

FIG. 7. True Stress-True Strain curves for 3% acid gellan gels (produced at pH 5 and pH 3) and soaked in excess acid solution pH 1 for various times.

FIG. 8. Young's moduli of 3% gellan gels as a function of length of exposure to an acidic soak at pH 1. Gels were initially made at pH 3 and 5.

FIG. 9. Young's modulus as a function of length of exposure of 3% gellan gels (initially produced at pH 2) to acid soaks at pH 1.

FIG. 10. True stress/true strain curves for mixed pectin/gellan acid gels produced at varying pH conditions. Each plot corresponds to mixed acid gels with varying hydrocolloid weight fractions of: a. 20/80, b. 40/60, c. 60/40 and d. 80/20, pectin (% weight fraction) over gellan (% weight fraction) respectively.

FIG. 11. Young's modulus (a.), bulk modulus (b.) and work of fracture (c.) for mixed pectin/gellan acid gels, produced at varying pH conditions, as a function of the weight fraction of each hydrocolloid.

FIG. 12. Young's and bulk moduli (a.) and work loss (b.) for a mixed pectin/gellan system subjected to repeated compression cycles where a maximum compression load of 250N was applied.

FIG. 13. Log-log plots of the bulk modulus (a.) and work loss (b.) data for a pectin/gellan system subjected to repeated compression cycles where a maximum compression load of either 250N or 200N or 150N was applied.

### GELLAN GUMS

Material and Methods

Low acyl Gellan Gum (Kelcogel F, CPKelco, UK) was used as the model hydrocolloid in this study. HCl acid was purchased from Fisher Scientific (Loughborough, UK).

Initially aqueous solutions of gellan with concentrations between 1 wt % and 4 wt % were prepared by dissolving the required amounts of the hydrocolloid in distilled water at 80° C. to avoid gelation. Subsequently the pH of the gellan solutions was adjusted by slow addition of 0.5 wt % HCl (at 80° C. to avoid gelation during the addition) and these acid solutions were then poured into cylindrical moulds, which were stored at 5° C. for at least 24 h to allow for gel formation. The natural pH of the gellan solutions was measured as 5.4. This was not dependent upon the gellan concentrations used. No attempt was made to further purify the gellan gum.

The structure of the produced acid-gels was assessed by performing a series of compression tests using a TA.XT.plus texture analyser (Stable Micro Systems Ltd., UK), fitted with a 40-mm diameter cylindrical aluminium probe. The diameter of the sample was always 22.5 mm and the length was between 15 mm and 25 mm. Thus the diameter of the samples was always a factor of approximately 2 smaller than the diameter of the probe. All measurements were carried out in triplicate with a compression rate of 1 mm/s. This was selected after carrying out measurements at a range of compression rates from 0.5 mm/s to 5 mm/s.

The response of the gels (produced at different pHs) to changes in pH was investigated by placing them within an acid solution (0.5 wt % HCl) for a period of time ranging between 1 and 6 hours.

The texture analysis data was converted into “true strain” and “true stress” rather than force and distance using the following equations:

Engineering Strain(e)=(l−L)/L
(l is the initial length and L is the final length)

True Strain(ε)=ln (1+e)

Engineering Stress(σ)=Force/Area

True Stress=(Engineering stress, σ)×(1+Engineering strain, e)

Results and Discussion

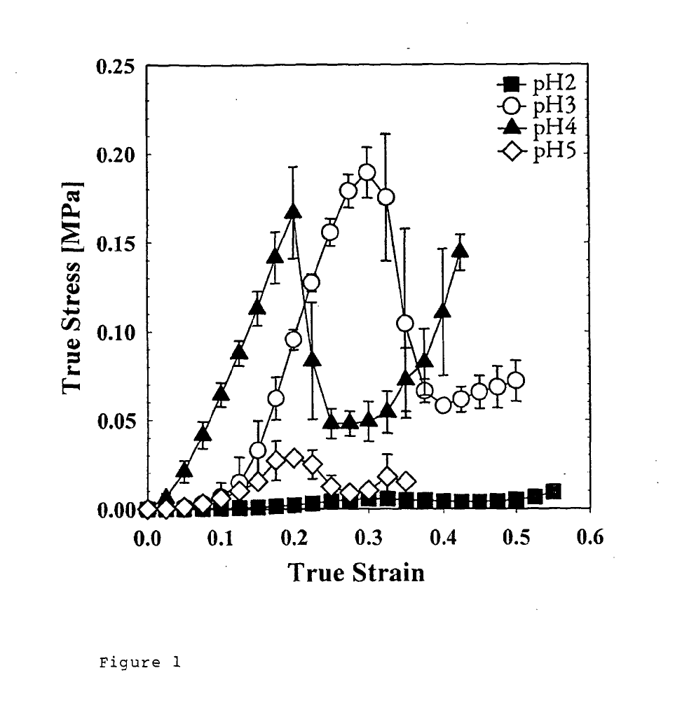

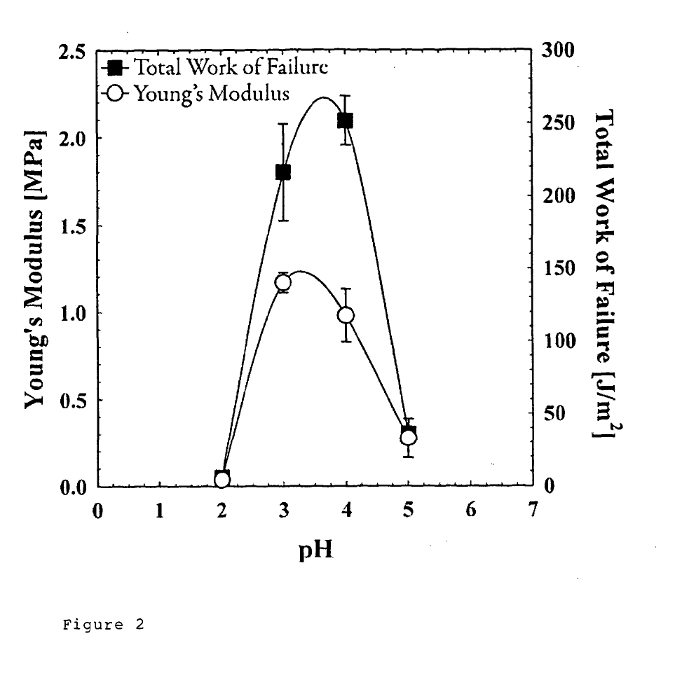

Initial experiments were carried out to investigate the effect of pH on the gelation and gel properties of low acyl gellan gum. The data obtained for 2% gellan are shown in FIG. 1. As can be seen from this figure, at pH 5 there is a gel produced, although it is very weak. At pHs above 5, no gelation was observed at 2% gellan concentration. As the pH is decreased to pH 4 and 3 the stiffness of the gel increases, and the gels show brittle behaviour with the rapid decrease in stress once the gel has failed at strains between 20 and 30%. Each of the curves in FIG. 2 are the average obtained for three repeats, using new samples for each measurement. Thus the data suggests that not only is the stiffness increasing, but so is the brittleness of the gel, so at pH 3 failure occurs at smaller strains. As the pH is lowered further to 2, the gel becomes very turbid and very weak with no clear fracture point. At this pH the samples were observed to go cloudy during addition of the acid. Thus even at 80° C. the sample is ordering and aggregating. It is very likely that the gel structuring at pH 2 is disrupted by the acidification process.

The data reported in FIG. 1 was analysed to obtain Young's moduli and the total work of failure (FIG. 2). In order to obtain the errors, the individual stress/strain curves were analysed and the mean and standard deviation calculated from the three curves. As can be seen from FIG. 2, both the Young's modulus and the Total Work increase on lowering the pH from 5 to 4 and then stay approximately constant at pH 3. As the pH is lowered further, the Young's modulus and Total Work of Failure drop close to zero. At this pH, the gels are visually very different, being very turbid rather than clear. The gels at this pH are therefore highly aggregated. The pH 2 samples were made several times and the results were always the same, even when very slow rates of acidification were used (taking 2 to 3 hours at 80° C.).

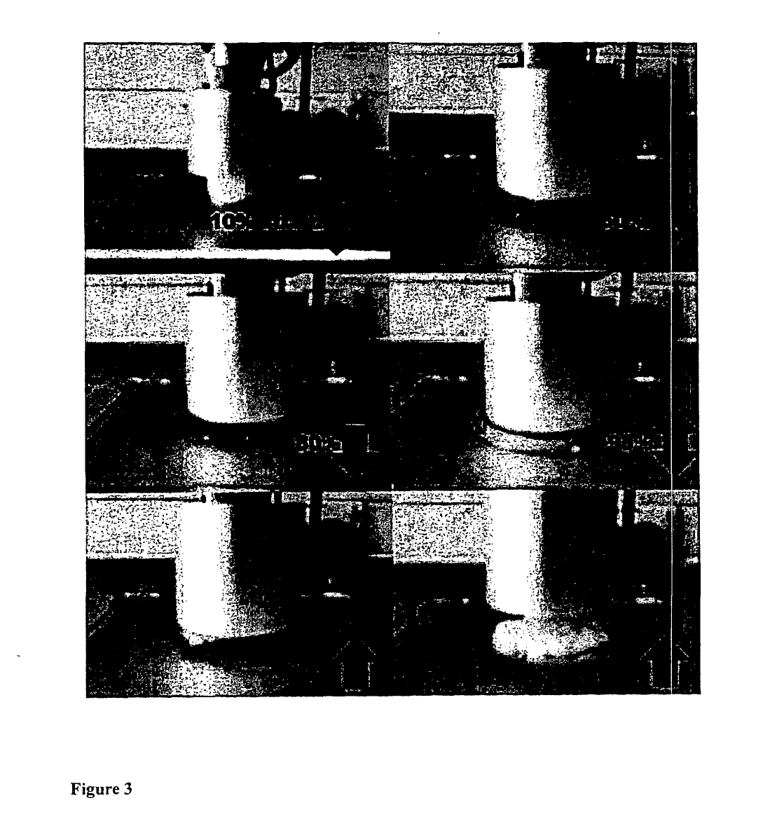

In addition to the visual differences with the gel at pH 2 they also show sponge like behaviour (FIG. 3). As can be seen in this figure, on initial compression of the gel at pH 2, the gel starts to look wet and a small amount of water appears to have been squeezed out. On further compression, significant amounts of water are squeezed out and as the extent of strain reaches approximately 95% the water can be seen around the probe. As the compression is removed, the gel is seen to spring back to some extent, although the cracks in the gel are clearly visible. The water, which has been squeezed out on compression, is sucked back into the gel so that after a few seconds no water can be seen. This behaviour was not observed at the higher pHs. Thus the gel is behaving like a sponge which is similar to the cryogels previously studied and reported by Lozinsky⁷. In cryogelation the ice formed forces the polymer network into large aggregates with large pours between them. Thus the water can be squeezed out, but the molecular network is largely intact allowing recovery after compression. As a consequence, the water is sucked back into the network as the gel springs back to its original or close to its original dimensions.

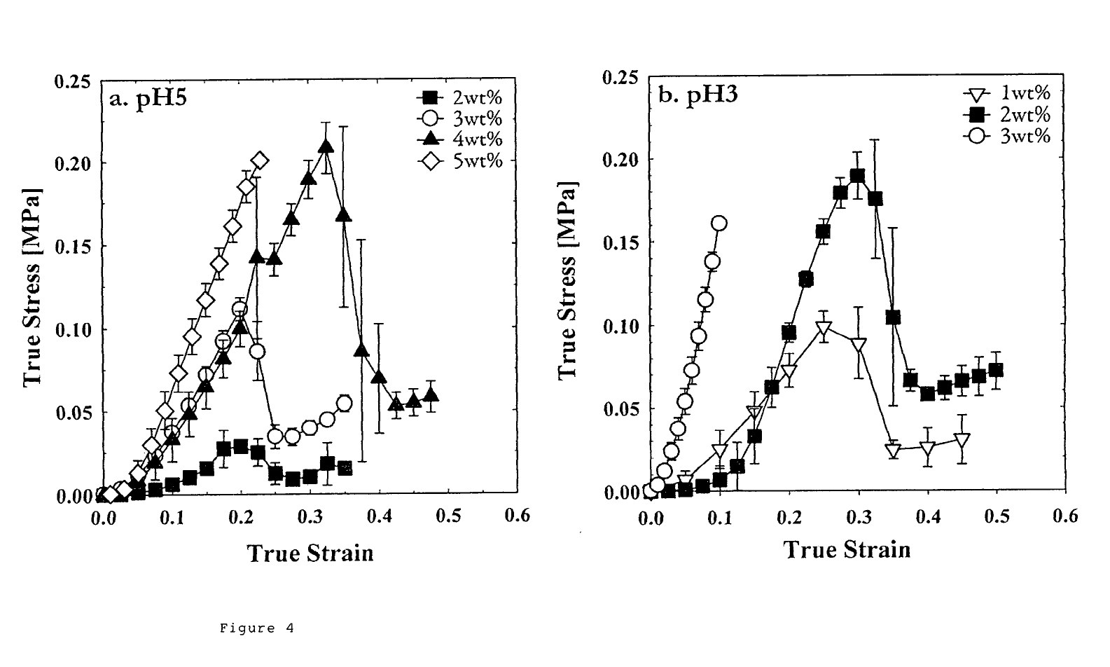

The concentration dependency of the gel strengths and total work of failure were investigated. The stress/strain curves for pH 5 and 3 are shown in FIG. 4. As can be seen, the Young's modulus increases as the concentration of the gellan is increased. At 3% pH 5 and 5% pH 3, the gels are so rigid that the instrument cut out before a failure was observed. Where failure was observed, the gels are again showing brittle fracture. Again the means and errors were obtained from at least triplicate runs. The standard deviations are small for all measurements until failure. From the pH 3 measurements it can be seen that not only does the Young's modulus increase with increasing concentration, but the failure strain also increases. This may well also be true for pH 5, but the data is not as clear as at pH 3. In order to analyse the data further, the Young's modulus and the Total Work of Failure were again calculated.

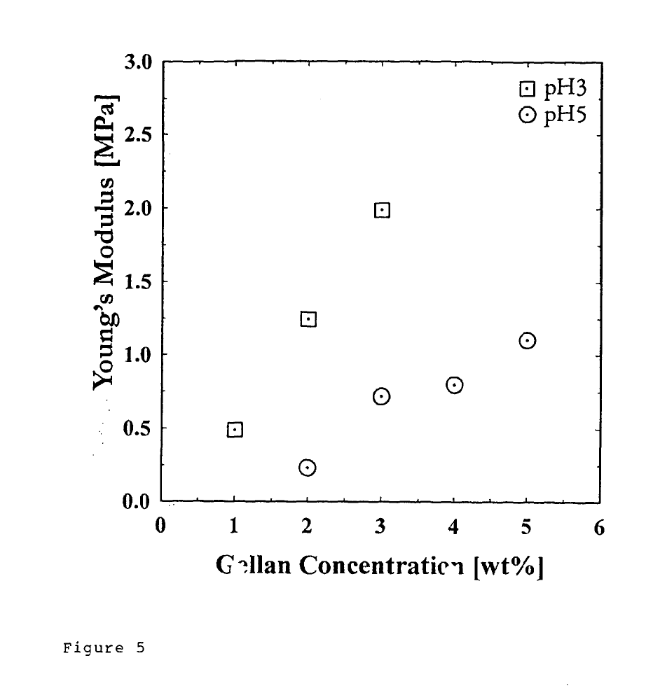

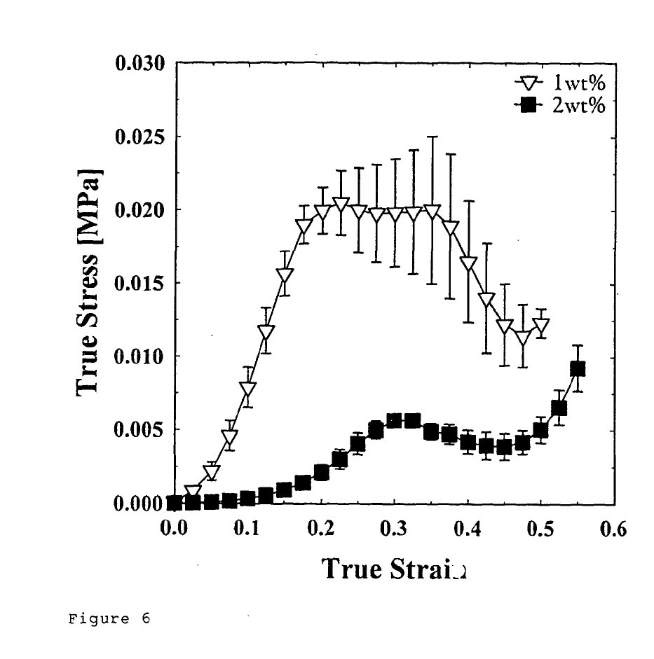

FIG. 5 shows the increase in Young's modulus as the concentration of the gellan is increased. Again each separate measurement has been analysed and then the mean and standard deviation at each strain calculated to give the points. The errors calculated are within the symbols shown on the plot. This figure shows that the Young's modulus at pH 3 is always above that observed at pH 5. Both the curves also show that there is a critical concentration for gelation, this is smaller at the lower pHs. For previous studies of hydrocolloid gels⁸, once the initial gelation has occurred the gel strength increases as squared dependency of the concentration. The work of failure also increase as the concentration of the gellan increased and the values calculated at pH 3 were higher than those calculated at pH 5, demonstrating that the gels become stronger as a consequence of greater numbers of cross-links between the hydrocolloid chains at the lower pH. However, as FIG. 6 shows, at pH 2 the gels are less brittle and weaker. This is due to the extensive aggregation discussed earlier in this article, resulting in sponge like properties i.e. water lose on compression and re-absorption as the compression is released. What might at first sight be surprising is that the gel is weaker at 2% than at 1% gellan, but this seems to be a consequence of greater aggregation in the higher concentration gel.

The results discussed so far show that the gellan gels produced at pH 2 are very different to those obtained at higher pHs. However, the evidence suggests that the extent of aggregation observed might well be as a consequence of the way the acid is added, even though a number of different rates of addition were investigated. In addition, when a gellan solution enters the stomach, the question is how does acidification occur and at what rate? If acidification leads to rapid gelation and highly aggregated sponge like structures, this may well limit the applicability of the approach. It might then be more effective to have a gellan gel in the food, which is then modified by the pH change. This was investigated by producing gels at pHs between 5 and 3. Gel cylinders were then soaked in an acid bath at pH 1 for different lengths of time applicable to the time that food might remain in the stomach.

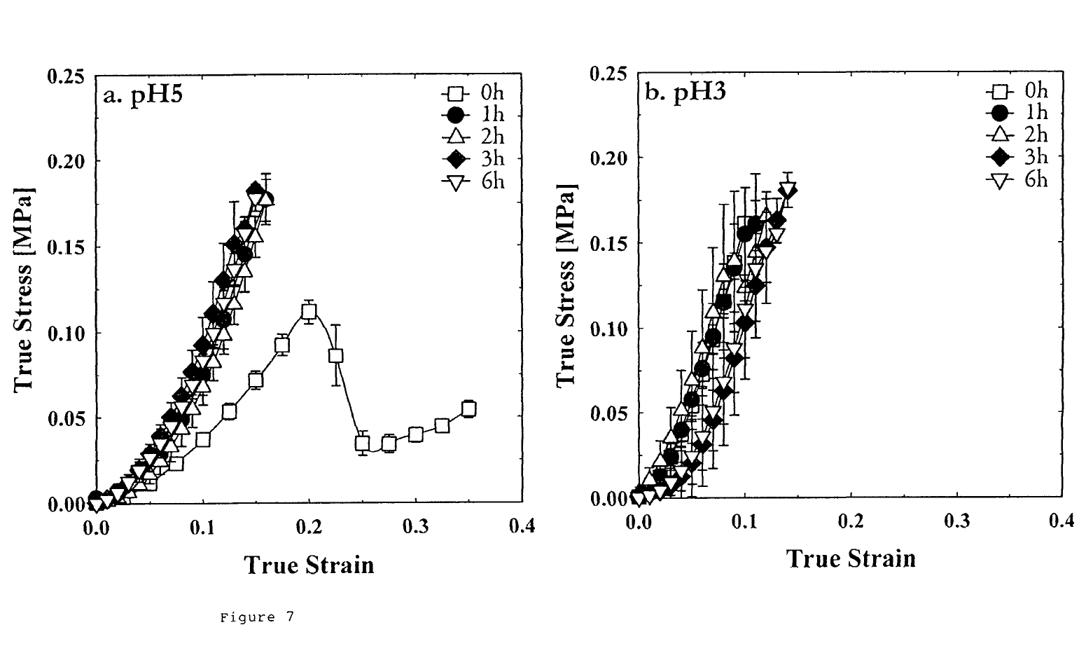

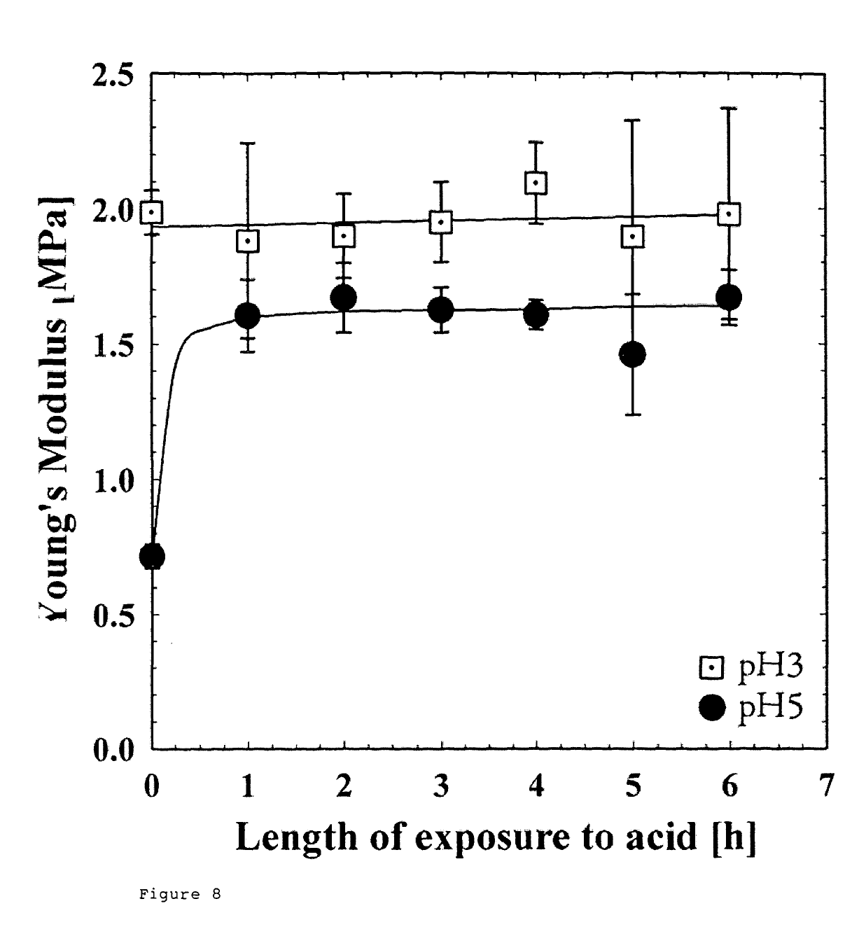

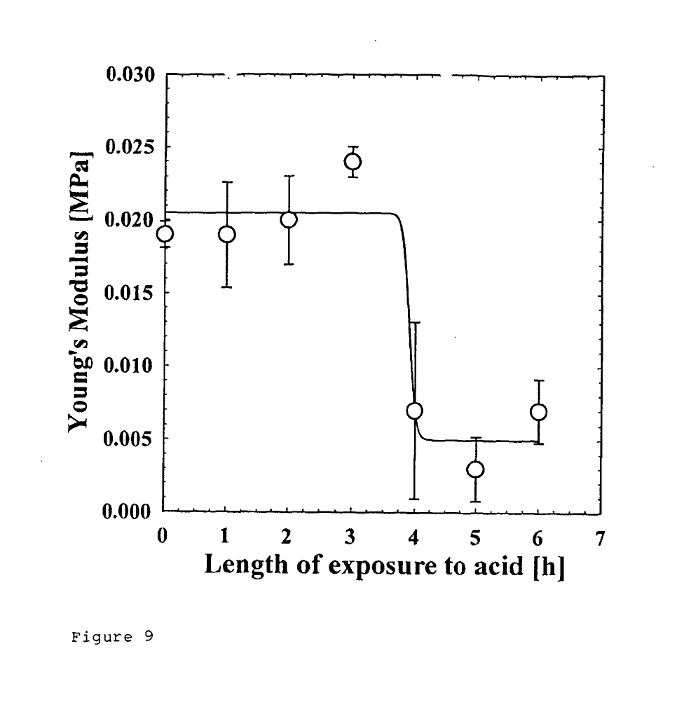

FIG. 7 shows the data obtained for gellan gels with starting pHs of 3 and 5. Again each measurement was carried out in triplicate to obtain the means and standard deviations shown in the figure. As can be seen from this Figure, the gel properties change on exposure to the pH 1. Thus with a starting pH of 5 the Young's modulus increases within the first hour of soaking and then stays constant for the remainder of the experiment and all of the curves overlay. The Young's modulus calculated from this data is in the range of 1.6 to 1.7 MPa (FIG. 8). This is very similar to the values calculated for pH 3 samples at this gellan concentration (i.e. approximately 2 MPa), but still significantly weaker. With a starting pH of 3, the Young's modulus is largely unaffected by the acid soak, although the data suggests that an initial lag period develops as the samples are exposed to acid soak, although this is not very significant. For the gels produced at pH 2 the data is again different (FIG. 9). Initially the Young's modulus stays reasonably constant for the first 3 hours, even with an indication that the modulus is increasing slightly. On further exposure the modulus decreases and stays at a lower value for the remaining 3 hours.

This data shows that what happens to gellan gels on soaking in acid depends on the gel microstructure before the soak. At pH 5, which is a reasonably weak gel, but with the cross-links already partially formed, the addition of further acid causes the gel to strengthen and remain clear. This indicates that the cross-linking has strengthened and the Young's modulus is slightly lower than the gels directly produced at pH, suggesting that the preformed aggregates have prevented the full gel strength from occurring. However, by performing the cross-links, extensive aggregation and precipitation has been prevented. When the gels are produced initially at pH 3, soaking in acid at pH 1 has little effect as cross-linking of the gels has already occurred in the preparation step. Further aggregation is prevented. There is an indication (the lag in the stress/strain curves) that further aggregation is occurring on exposure to the soak, but only very slowly. When the gels are already extensively aggregated (pH 2) the soaking seems to drive the aggregation further with a further loss of Young's modulus, again this taking some time to occur. It is likely that the time change is related to the dimensions of the gel used in the soak experiment i.e. the time required for diffusion of the H⁺ ions across the whole sample.

Conclusions

The acid-induced gelation of Low Acyl Gellan Gum has been investigated. The structure of the acid-gels was found to depend on the pH environment as well as the concentration of hydrocolloid used during their production. Post-production exposure to an acidic environment was found to affect gel structure and the response to the exposure was related to the pH values used during the acid-gel production. These initial findings are promising as they clearly demonstrate that structuring as well as de-structuring of gellan acid-gels can be controlled by both the process used for their production and by exposure to an acidic environment.

Moreover the findings demonstrate that such gels are suitable to be used in comestible products for appetite suppression to support an appropriate eating regime for control of calorie intake.

Such gels may be provided as drinks or soft foods such as proprietary diet products sold as alternatives to meals. Additional additives such as flavourings, colours or energy release materials such as starch may be added. Hydrocolloids, such as alginates may also be added to alter the texture of the product.

### MATERIALS & METHODS

Mixed Hydrocolloid System

Low-methoxy pectin and low-acyl gellan gum (both from Kelcogel F, CPKelco, UK) were used as the model “acid-sensitive” mixed hydrocolloid system in this study. The water used for all the prepared hydrocolloid solutions was passed through a reverse osmosis unit and then a milli-Q water system. HCl acid was purchased from Fisher Scientific (Loughborough, UK) and was used for the direct acidification of all produced acid gel structures. All materials were used with no purification or modification of their properties.

Preparation of Mixed Hydrocolloid Acid-Gels

Aqueous mixed hydrocolloid solutions of pectin and gellan (always adding up to a total hydrocolloid concentration of 3 wt %) were prepared by dissolving the required amounts of each in distilled water at ˜80° C. to avoid gelation. These mixed biopolymer solutions were then poured into cylindrical moulds (22.5 mm inner diameter and 50 mm height) and subsequently acidified either by (“fast acidification”) direct addition (drop-wise) of 0.5 wt % HCl (also at 80° C.) or (“slower acidification”) by placing the solutions within dialysis tubing and immersing these in an acid bath at ˜pH 1 for 24 h. In either case texture analysis (see following section for details) of all acid-gel samples was carried out 24 h after preparation.

Texture Analysis

The structuring process (structure development) of the prepared (by fast acidification) mixed hydrocolloid acid-gels was assessed by performing a series of compression tests using a TA.XT.plus texture analyser (Stable Micro Systems Ltd., UK), fitted with a 40-mm diameter cylindrical aluminium probe. The experimental protocol followed during the performed texture analysis in this study is the same as in [10]. The force/distance (of compression) data from texture analysis were used to obtain the true stress/true strain curves for all mixed hydrocolloid acid-gels according to [10]. Then the true stress/true strain curves were used to calculate the Young's modulus (a measure of the structure's elasticity) [11], the “bulk modulus” (a measure of the structure's stiffness/deformability) [12] and finally the “total work of failure” [13] (given as work per unit volume in this study) which is the energy required for the structure to fail. A schematic description of how the Young's and bulk moduli and the total work of failure can be calculated is given in [10].

In addition to conventional compression analysis tests, the prepared (by slower acidification) mixed acid-gels were subjected to a series of repeated compression cycles in order to investigate their “de-structuring” (structure breakdown) process. Pectin and gellan were mixed at a 50/50 weight ratio to give a 3 wt % total hydrocolloid concentration. In this case compression was allowed to progress only up to a maximum applied compressive load which was lower than that required to cause structure failure. Subsequently the load was completely removed at the same rate and the process was repeated until the structure eventually fails or for at least 200 compression cycles. In these cycling experiments two true stress/true strain curves, for each cycle, can be plotted; the first curve giving the structure's response to the applied load and the second its response when the load is removed. The Young's and bulk moduli can be calculated as previously, from the first of these two curves, but in addition the work that is lost at the end of each cycle (“work loss”) can be calculated (the area between the two curves), which gives a measure of the structural changes that have taken place.

Results & Discussion

“Structuring” (Acid-Gelation) Process of Acid-Sensitive Mixed Hydrocolloid Gels

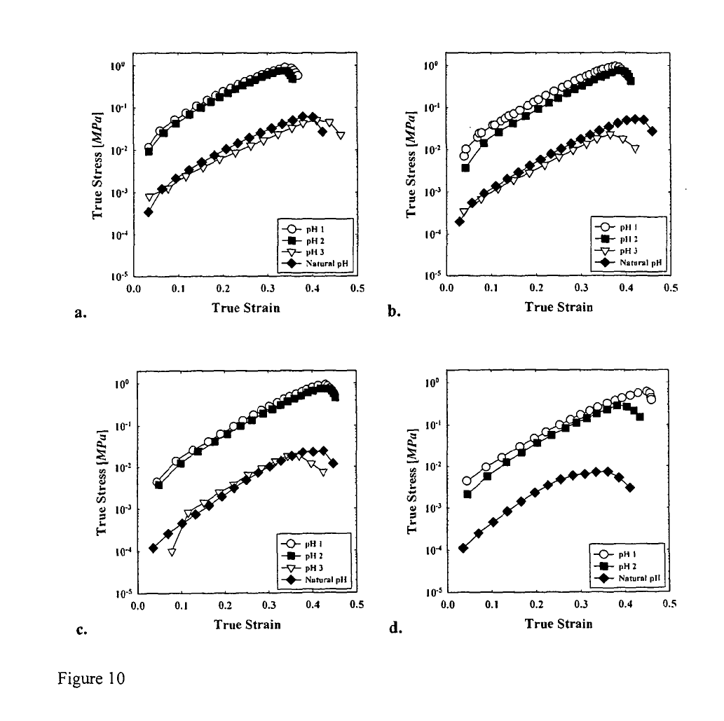

The process of acid-gelation of mixed pectin/gellan systems of varying hydrocolloid weight fractions and under varying pH conditions was investigated. Although low-methoxy pectin and low-acyl gellan gum were mixed at different weight ratios, the total biopolymer concentration in the solutions was kept constant at 3 wt %. These mixtures were acidified, by direct addition of hydrochloric acid, to induce a range of pH conditions, and the textural behaviour of the produced mixed acid gels was studied. The data obtained from the carried out textural analysis are plotted in FIG. 10.

The pH conditions induced during the (acid) structuring process seem to significantly affect the structural properties of the resulting mixed pectin/gellan acid gels. Lowering the pH from the naturally occurring one (˜pH 4.8) to pH 3 does not appear to cause a noticeable change to the systems' structural properties (FIG. 10). Nonetheless an additional pH reduction to pH 2 results in significantly “stronger” acid gels, although acidifying the structures to a greater extent (to pH 1) does not induce any further strengthening of the gels (FIG. 10). These observations are in contrast to what has been reported for pure gellan acid gels [10]; also acidified by direct addition of HCl. In the case of pure gellan acid gels [10] lowering the pH from natural to pH 3 results in much stronger structures, with a further pH reduction to pH 2 giving gels of significantly weaker properties. The reason for the latter is that ordering/aggregation between individual hydrocolloid (gellan) chains in systems under such low pH conditions occurs immediately upon acidification; “over-structuring”. As a result an almost sponge-like (“weak”) structure is created rather than a homogeneous (“stronger”) one. It becomes clear that the acid gelation (“structuring”) process for a mixed biopolymer system is slower than the process as it takes place for either of the biopolymers as a single system. Even more this suggests that the acid gelation (rate) of a mixed biopolymer system, and therefore the strength of the resulting acid structure, can be potentially controlled by selecting the weight fraction of each component.

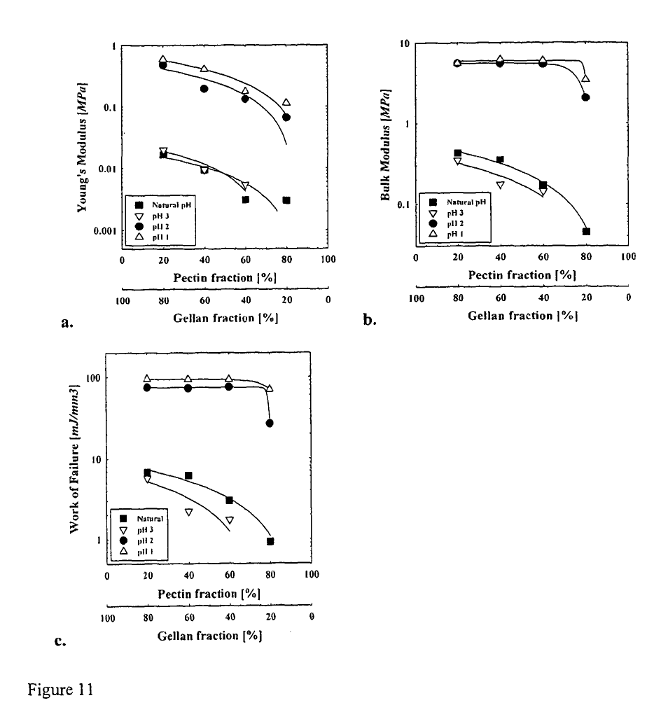

This is clearly demonstrated by calculating the Young's and bulk moduli and work of fracture for these acid structures from the true stress/true strain curves given in FIG. 10 and plotting these as a function of the weight fraction of each of the hydrocolloids in the mixed system (FIG. 11). FIG. 11 further supports what was earlier suggested to be the effect of pH on the structural properties of these acid mixed gels; i.e. no significant increase in gel strength is observed by lowering the pH from natural to pH 3 and that only a further decrease to pH 2 is capable to provide considerably stronger structures, which finally are marginally strengthened at pH 1. The effect of the weight fraction of each component on the structural properties of mixed acid gels is also pH related. At either natural pH (˜pH 4.8) or pH 3, as the pectin content is increased (or the gellan content is decreased), the acid mixed structures become less elastic (FIG. 11a), less firm (FIG. 11b) and overall weaker, (FIG. 11c). The reason for this is because pure gellan forms stronger acid gels than pure pectin under these acidic conditions. On the other hand, at either pH 2 or pH 1, as the pectin content is increased (or the gellan content is decreased), the mixed acid gels initially retain their firmness (FIG. 11b) and overall strength (FIG. 11c) and weaker structures are only observed for the highest pectin fraction gels (80 wt % pectin). It should be noted though that even at these low pH values (pH 2 and/or pH 1) the acid structures still (as for natural pH and/or pH 1) appear to lose their elasticity with increasing pectin content (or with decreasing gellan content). Nonetheless the fact remains that by incorporating gellan within a mixed biopolymer system it is possible to control its rate of acid gelation and avoid the “over-structuring” issues shown for pure gellan acid gels formed at pH values relating to the conditions found in the stomach during digestion (pH 1-2) [10].

“De-Structuring” Process of Mixed Hydrocolloid Acid Gels

The “de-structuring” (structure breakdown) process of these mixed pectin/gellan systems was also investigated. For this set of experiments pectin and gellan were mixed at a constant weight ratio of 50 wt %-50 wt % (still giving a total hydrocolloid concentration of 3 wt %) and the acid gels were now created by placing the mixed biopolymer solutions within dialysis tubing and subsequently immersing these in an acid bath at pH 1 for 24 h. after this period the formed acid gels were subjected to repeated compression cycles and the changes in their physical properties were monitored. The maximum load that was allowed to be applied during these repeated compression cycles was constant during each test (varied from test to test) but was always lower than the load experimentally determined to result in the breakdown of the structure; a load of 300 N in the case of a 50/50 pectin/gellan acid mixed gel.

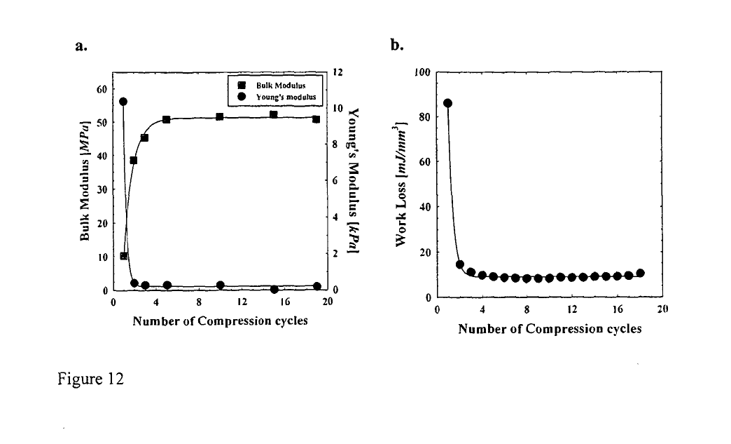

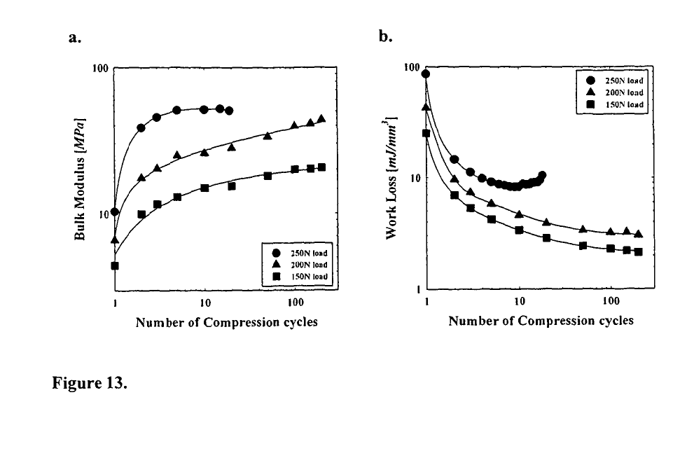

FIG. 12 shows the changes in the bulk and Young's moduli, and the work loss for a mixed pectin/gellan system subjected to repeated compression cycles where a maximum compression load of 250N was allowed to be applied. What can be clearly demonstrated in FIG. 12 is the magnitude and mode of structural changes that the mixed acid structures undergo during these repeated compression cycling experiments and until eventually, after 19 compression cycles, they “fail”. First of all, and almost immediately (after the first compression cycle), the elasticity (Young's modulus) of the mixed acid gels is significantly reduced (FIG. 12a). Given the fact that these acid gel structures display an elastic behaviour only at very low strains (usually up to ˜0.05 [10]) and since deformation in these repeated compression cycling experiments proceeds to a strain of about 0.43, then it is not by any means surprising that, after the first compression, the mixed acid gels do not retain their initial elasticity, the level of which remains more or less unchanged with subsequent compression cycles. On the other hand, the bulk modulus of the mixed acid gels is increased for about four compression cycles after which it remains unaffected until the structure breaks down (FIG. 12a). What the bulk modulus data demonstrate is that the mixed acid gels are effectively “compacted” during the initial compression cycles, which results in an increase in the firmness of the structures as shown with further compressions. In fact this so-called “compaction” phenomenon can be also “observed” microscopically as the systems now enters a non-elastic region of the deformation process where individual polymer chains (for both hydrocolloids) are packed very closely to one another. This is in agreement with the observations regarding the loss of the elasticity of the structures suggested by the Young's modulus data; structures become more firm and less elastic. The work loss data (FIG. 12b) also reflect the observations made based on the Young's and bulk moduli. FIG. 12b shows that after an initial (after the first compression cycle) large loss of work/energy, corresponding to the loss of the elasticity of the structures, these acid gels are not affected by further cycling. It is worth pointing out that perhaps after about eleven compression cycles a slight increase in work loss can be seen which persists until structure failure. If this is a true structure response, which in fact appears to be more evident when the data is plotted on a logarithmic scale (see FIG. 13b ()), then it could be potentially regarded as a “precursor” for the structures' failure.

The same repeated compression cycles tests were also performed for even lower applied maximum compression loads than the 250N used before. FIG. 13 shows the changes in the bulk modulus (FIG. 13a) and the work loss (FIG. 13b) for a mixed pectin/gellan system subjected to repeated compression cycles where a maximum compression load of 200N (▴) or 150N (▪) was applied. The striking difference, from what was observed for 250N (), is that in both cases where either a 200N or 150N maximum compression load was applied the acid mixed gels did not exhibit structure failure during testing; this was after just over 30 min of repeated compression cycling and about 200 compression cycles. In addition the data suggests that the rate of “compaction” (bulk modulus) of the acid structures as well as that of work/energy loss during cycling are both much slower than what was previously shown for the 250N load. In fact, in contrast to what was demonstrated for the higher load, acid mixed gels subjected to the 200N or the 150N loads continue to undergo structural changes for the whole duration of the tests; structural properties for the gels subjected to 250N remained unchanged after a few compression cycles.

### CONCLUSION

The acid gelation (“structuring”) and structure break down (“de-structuring”) processes for a mixed low-methoxy pectin/low-acyl gellan gum system were investigated. Structuring of these systems can be controlled by variations in the weight fractions of the individual components. Furthermore, acid gelation in mixed systems appears to be more “efficient”, especially at low pH conditions (pH 1 and pH 2) as no “over-structuring” occurs as in single biopolymer systems. This resulted in mixed biopolymer acid gels that are stronger than those created from either of the two macromolecules alone, at such low pH environments. The fact that acid gelation in mixed systems can be better controlled suggests that these systems would be more successful candidates for the self-structuring approach. These acid structures were also shown to withstand several cycles of compressions, depending on the load applied. Understanding the relation between applied load and eventual structure failure (after compression cycling) can help us predict and therefore control when acid gels, after structuring, will eventually be broken down by the forces applied in the stomach.

### REFERENCES

1. I. Norton, S. Moore and P. Fryer, Obesity Reviews, 2007, 8, 83-88.
2. I. Norton, P. Fryer and S. Moore, Aiche Journal, 2006, 52, 1632-1640.
3. K. I. Draget, G. Skjak-Braek and B. T. Stokke, Food Hydrocolloids, 2006, 20, 170-175.
4. I. T. Norton, W. J. Frith and S. Ablett, Food Hydrocolloids, 2006, 20, 229-239.
5. C. L. Hoad, P. Rayment, R. C. Spiller, L. Marciani, B. D. Alonso, C. Traynor, D. J. Mela, H. P. F. Peters and P. A. Gowland, Journal of Nutrition, 2004, 134, 2293-2300.
6. F. Yamamoto and R. L. Cunha, Carbohydrate Polymers, 2007, 68, 517-527.
7. V. I. Lozinsky, L. G. Damshkaln, R. Brown and I. T. Norton, Journal of Applied Polymer Science, 2002, 83, 1658-1667.
8. A. H. Clark and S. B. Rossmurphy, British Polymer Journal, 1985, 17, 164-168.
9. Capel F., Nicolai T., Durand D., Boulenguer P. & Langendorff V. 2006. Calcium and acid induced gelation of (amidated) low methoxyl pectin. Food Hydrocolloids, 20(6), 901-907.
10. Norton A. B., Cox P. W. & Spyropoulos F. Acid gelation of low acyl gellan gum relevant to self-structuring in the human stomach, Food Hydrocolloid, doi:10.1016/j.foodhyd.2010.10.007.
11. Smidsrød O., Haug A. & Lian B. 1972. Properties of Poly(1,4-hexuronates) in the Gel State. I. Evaluation of a Method for the Determination of Stiffness. Acta Chemica Scandinavica, 26, 71-78.12. Nussinovitch, A. 2004. From simple to complex hydrocolloid cellular solids. In: Williams P. A. & Phillips G. O. (Eds.). Gums and stabilizers for the food industry 12 (pp. 32-42). The Royal Society of Chemistry, Cambridge, UK.
13. Kaletunc G., Normand M. D., Nussinovitch A. & Peleg M. 1991. Determination of elasticity of gels by successive compression-decompression cycles. Food Hydrocolloids, 5, 237-247.

1-14. (canceled)

15. An appetite suppressing comestible product comprising an acid gellable hydrocolloid gellan gum.

16. The product of claim 15, wherein the acid gellan gum is a low acyl gellan gum.

17. The product of claim 15, comprising 1.5% to 5% by weight of gellan gum.

18. The product of claim 15, comprising one or more additional hydrocolloids.

19. The product of claim 15, comprising a mixture of high acyl gellan gum and a low acyl gellan gum.

20. The product of claim 15, comprising an additional hydrocolloid which is alginate.

21. The product of claim 15, comprising an additional hydrocolloid which is a pectin.

22. The product of claim 18, wherein the total amount of the acid gellable hydrocolloid gellan gum and the one or more additional hydrocolloids is 1.5% to 5% by weight of the comestible product.

23. The product of claim 18, wherein the acid gellable hydrocolloid gellan gum and the one or more additional hydrocolloids are provided in an amount of 80%-20 wt % gellan gum to 20%-80 wt % additional hydrocolloids, based on the total amount of hydrocolloids.

24. The product of claim 15, additionally comprising an energy release material.

25. The product of claim 15, comprising an energy release material which is a carbohydrate.

26. The product of claim 15, comprising one or more nutrients.

27. The product of claim 15, additionally comprising one or more flavorings or colorings.

28. The product of claim 15 in the form of a drink or soft food.

29. The product of claim 15, comprising a low methoxy pectin as an additional hydrocolloid.

30. The product of claim 15, comprising an energy release material selected from starch granules, sugar and edible oil droplets.

31. The product of claim 15, comprising one or more vitamins or minerals.
